(19) United States
(12) Patent Application Publication
(10) Pub. No.: US 2011/0203779 A1
(43) Pub. Date: Aug. 25, 2011

(54) UNINTERRUPTIBLE COOLING SYSTEM AND APPARATUS

(76) Inventor: Warwick Graham Andrew Dawes, Hong Kong (CN)

(21) Appl. No.: 12/860,450

(22) Filed: Aug. 20, 2010

Related U.S. Application Data
(63) Continuation-in-part of application No. 12/031,827, filed on Feb. 15, 2008, now abandoned.

(51) Int. Cl. F28F 13/00; H02J 9/06

(52) U.S. Cl. 165/121; 307/64

(57) ABSTRACT

A cooling system and power control apparatus provides an uninterruptible power supply. In one embodiment, the uninterruptible power supply provides power to an air conditioning system for cooling telecommunications equipment in the case of an AC power failure. Embodiments of the present invention include a first port configured for coupling with a primary power supply; a second port configured for coupling with a secondary power supply, wherein the secondary power supply is a backup power source that allows the cooling system to operate when the primary power supply exceeds predetermined operating conditions. A power circuit including a DC bus delivers power from the first port and the second port to a plurality of switches for controlling cooling equipment. A control circuit is configured to control power flow from the first port and power flow from the second port to the DC bus and the first plurality of switches.

### RELATED APPLICATIONS

This application is a Continuation-in-Part of U.S. patent application Ser. No. 12/031,827, filed Feb. 15, 2008, entitled “Uninterruptible Cooling System and Apparatus,” which is hereby incorporated by reference.

### FIELD OF THE INVENTION

Embodiments of the present invention are directed to an uninterruptible cooling system and apparatus, and in particular, the cooling of equipment powered by an uninterruptible power supply.

### BACKGROUND OF THE INVENTION

It is general practice to provide backup power to critical equipment, such as telecommunications equipment, where a high level of availability is desired and an interruption in operation due to an AC (alternating current) supply failure is unacceptable. Telecommunications equipment is generally powered via a Telecom Rectifier which converts the AC mains input power to a DC (direct current) voltage suitable for powering the telecommunications equipment and for charging a backup battery. In the case of an AC mains supply failure, the battery continues to supply power to the telecommunications equipment without interruption for a period of time determined by the battery capacity.

Telecommunications equipment generates heat as a byproduct of operation. Telecommunication sites, such as mobile base transceiver stations, central offices, and mobile switching centers, are therefore typically equipped with cooling (air conditioning) systems to remove this heat and maintain the environment where the telecommunications equipment is installed at a suitable operating temperature.

A short interruption in the operation of the cooling system is normally not critical for the operation of the telecommunications equipment, but a longer interruption in the operation of the cooling system can result in the build-up of heat in the site and the resultant interruption in the operation of the critical telecommunications equipment due to excessively high temperatures. Measures are therefore taken to mitigate against a cooling system failure. These measures can include, for example: the provision of redundant cooling machines to guard against the failure of a single machine due to mechanical or electrical causes; the provision of diesel generators to provide AC backup to the air conditioners in the case of an AC mains failure; the provision of phase change materials in the site which prolongs the time taken for the temperature at the site to rise; or a combination of the above.

Many of these measures require the purchase of expensive, redundant equipment and provide an insufficient and/or inefficient solution. Accordingly, there is a need for a cooling system and apparatus that solves the shortcomings of existing systems.

### SUMMARY OF THE INVENTION

In accordance with one embodiment of the present invention, a cooling system including a compressor motor and a compressor operated by the compressor motor is disclosed. The cooling system further includes a first port configured for coupling with a primary power supply; a second port configured for coupling with a secondary power supply, wherein the secondary power supply is a backup power source that allows the cooling system to operate when the primary power supply exceeds predetermined operating conditions; a power circuit including a DC bus and a first plurality of switches, the DC bus coupled to the first port and the second port, the power circuit configured to deliver power from the first port and the second port to the DC bus and the first plurality of switches, wherein the first plurality of switches are configured to receive power from the DC bus and power the compressor motor; and at least one control circuit configured to control power flow from the first port and power flow from the second port to the DC bus and the first plurality of switches, the at least one control circuit configured to control the compressor motor.

In accordance with another embodiment of the present invention, a power control apparatus for delivering electrical power from a first power supply and a second power supply to an air conditioning system is disclosed. The power control apparatus includes a first input to receive power from the first power supply; a second input to receive power from the second power supply; a current shaping circuit coupled to the first port and the second port, the current shaping circuit having a DC bus; a plurality of switches coupled to the first port and the second port by the current shaping circuit, the plurality of switches configured to operate one or more cooling system devices; and a control circuit configured to monitor power received from the first input, the control circuit further configured to monitor power received from the second input and selectively deliver power from either the first input or the second input based on predetermined operating conditions.

In accordance with yet another embodiment of the present invention, a cooling system coupled to a first power supply and a second power supply is disclosed. The cooling system includes means for delivering power to cooling equipment; means for controlling a DC bus voltage; and means for monitoring an operating condition of the first power supply and monitoring an operating condition of the second power supply, wherein the means for delivering power to the cooling equipment delivers power from the first power supply during normal operation, and the means for delivery power to the cooling equipment delivers power from the second power supply when the operating condition of the first power supply exceeds predetermined operating parameters.

Still other embodiments of the present invention will become readily apparent to those skilled in the art from the following detailed description, wherein embodiments of the invention are described by way of illustration. As will be realized, the invention is capable of other and different embodiments and its several details are capable of modifications in various respects, all without departing from the spirit and the scope of the present invention.

### BRIEF DESCRIPTION OF THE DRAWINGS

FIG. 1 is a block diagram showing a cooling system, in accordance with embodiments of the present invention.

FIG. 2 is a circuit diagram of a power circuit, in accordance with embodiments of the present invention.

FIG. 3 is a circuit block diagram of a first control circuit for use with the power control system, in accordance with embodiments of the present invention.

FIG. 4 is a circuit block diagram of a second control circuit for use with the power control system, in accordance with embodiments of the present invention.

FIG. 5 is a circuit block diagram of a third control circuit for use with the power control system, in accordance with embodiments of the present invention.

FIG. 6 is a circuit diagram of a power circuit, in accordance with an alternative embodiment of the present invention.

FIG. 7 is a circuit diagram of a power circuit, in accordance with an alternative embodiment of the present invention.

FIG. 8 is a circuit diagram of a power circuit, in accordance with an alternative embodiment of the present invention.

FIG. 9 is a circuit diagram of a power circuit, in accordance with an alternative embodiment of the present invention.

FIG. 10 is a circuit diagram of a power circuit, in accordance with an alternative embodiment of the present invention.

FIG. 11 is a circuit diagram of a power circuit, in accordance with an alternative embodiment of the present invention.

FIG. 12 is a flowchart diagram illustrating a power control system decision process, in accordance with an embodiment of the present invention.

FIG. 13 is a circuit diagram including further detail of an embodiment of power and control circuit.

FIG. 14 is a block diagram including further detail of an embodiment of changeover relay control.

FIG. 15 is a block diagram including further detail of an embodiment of temperature control circuit.

### DETAILED DESCRIPTION

In the following description, reference is made to the accompanying drawings where, by way of illustration, specific embodiments of the invention are shown. It is to be understood that other embodiments may be used as structural and other changes may be made without departing from the scope of the present invention. Also, the various embodiments and aspects from each of the various embodiments may be used in any suitable combinations. Accordingly, the drawings and detailed description are to be regarded as illustrative in nature and not as restrictive.

Generally, embodiments of the present invention are directed to a cooling system and apparatus powered by an uninterruptible power supply. In one application, embodiments of the system and apparatus are used to cool equipment, such as telecommunications equipment or other critical equipment. However, embodiments of the present invention can also be extended to other applications requiring the use of uninterrupted cooling or air conditioning, such as for process applications and comfort cooling applications. Additionally, the various embodiments and implementations of an uninterruptible power supply system and apparatus, which are described as used for a cooling system, could also be used for other applications, other than cooling, where uninterruptible operation is required.

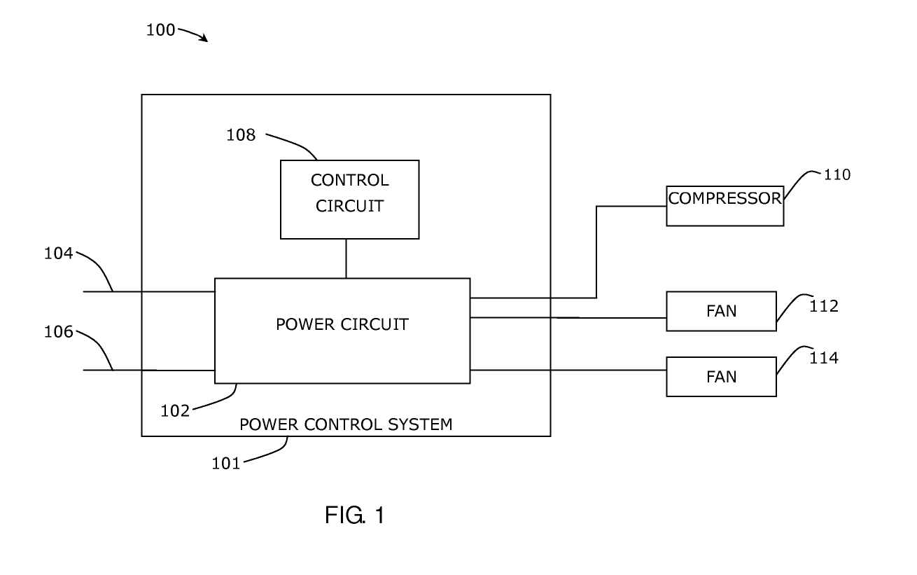

Referring now to the figures, FIG. 1 is a block diagram showing a cooling system 100, in accordance with embodiments of the present invention. The cooling system includes a power control system 101 and a power circuit 102 having a first port 104 that receives power from a primary power supply, typically AC power, and a second port 106 that receives power from a secondary power supply, such as DC power in the form of one or more batteries, or an alternative DC source such as a fuel cell, DC generator, or other power supply. The power circuit 102 receives power from the first port 104 during normal operation of the cooling system. In the case of an AC power failure, the power circuit 102 receives power from the second port 104.

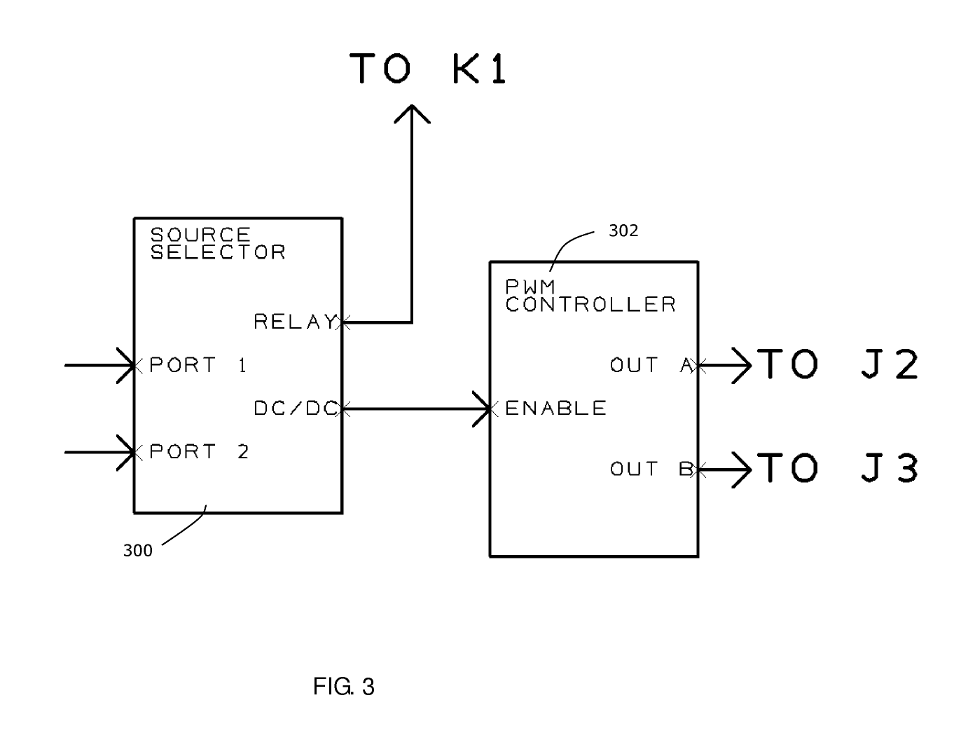

A control circuit 108 is operably coupled to the power circuit 102. The control circuit 108 operates in conjunction with the power circuit 102. The control circuit 108 may include a plurality of control circuits. For example, the functions performed by the control circuits illustrated and described with reference to FIGS. 3 to 5 may be incorporated into the control circuit 108. It will be appreciated that any number of required circuits may be incorporated separately or may be combined in to a single device, such as a microcontroller, microprocessor or other integrated circuit device.

The power circuit 102 is coupled to a compressor 110, an outdoor fan 112, and an indoor fan 114, each driven by a motor powered by the power circuit. The compressor 110, the outdoor fan 112, and the indoor fan 114 are typical components of an air conditioning system. However, it will be appreciated that the power control system 100 can be used to power any suitable air conditioning system, and the compressor 110, the outdoor fan 112, and the indoor fan 114 are included to illustrate example components of an air conditioning system.

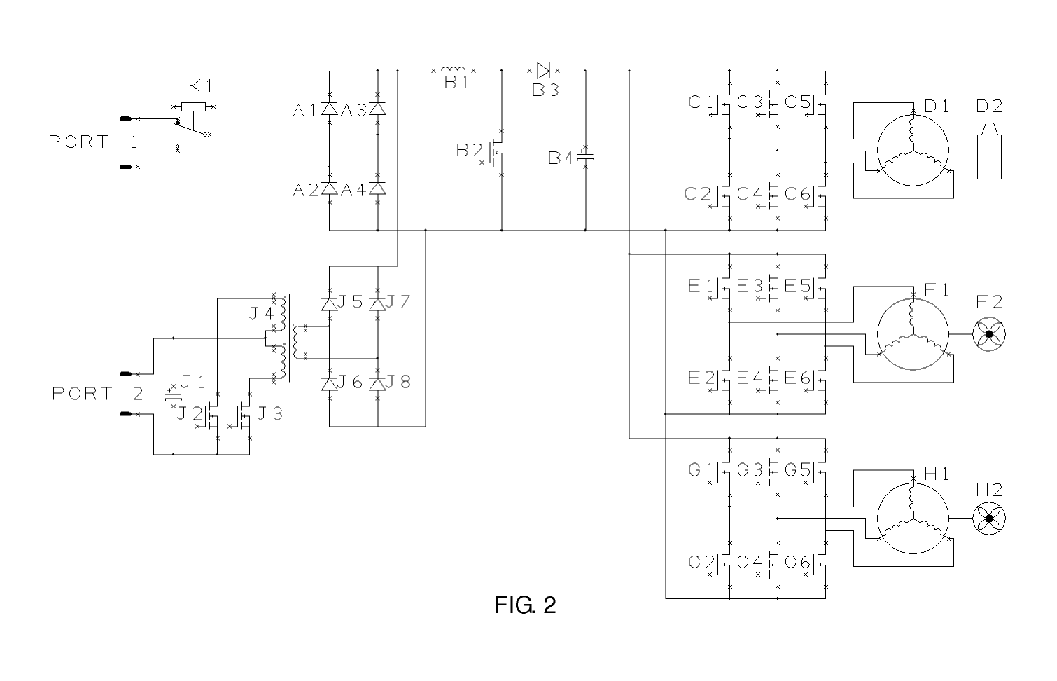

FIG. 2 is a circuit diagram of the power circuit, in accordance with embodiments of the present invention. The power circuit is operably coupled to an air conditioning system comprising a plurality of motors (D1, F1, H1), a compressor D2, an outdoor fan F2 and an indoor fan H2. The power circuit includes two input power supply ports, Port 1 and Port 2. Port 1, to which AC mains is connected, is the primary source of power. Port 2, to which DC backup power is connected, is the secondary source of power.

Power is drawn from Port 1 when the AC mains supply is within specified operating conditions. Power is drawn from Port 2 when the AC mains supply is not within specified operating conditions and the DC backup supply is within specified operating conditions. A first control circuit detects the conditions of Port 1 and Port 2 and the control circuit selects operation from Port 1 or Port 2 by controlling relay K1 and semiconductor switches J2 and J3 accordingly based on the detected conditions. An example first control circuit for performing this detection and control is described with reference to FIG. 3.

An input rectification circuit comprises diodes A1, A2, A3 and A4, which converts the sinusoidal AC input voltage to rectified sinusoidal DC voltage when relay K1 is closed. A push-pull DC/DC converter circuit comprises capacitor J1, semiconductor switches J2 and J3, transformer J4 and diodes J5, J6, J7, J8, which converts the voltage at Port 2 to a level suitable for input to a boost input current shaping circuit, and provides galvanic isolation from the AC mains, which may be required at Port 2.

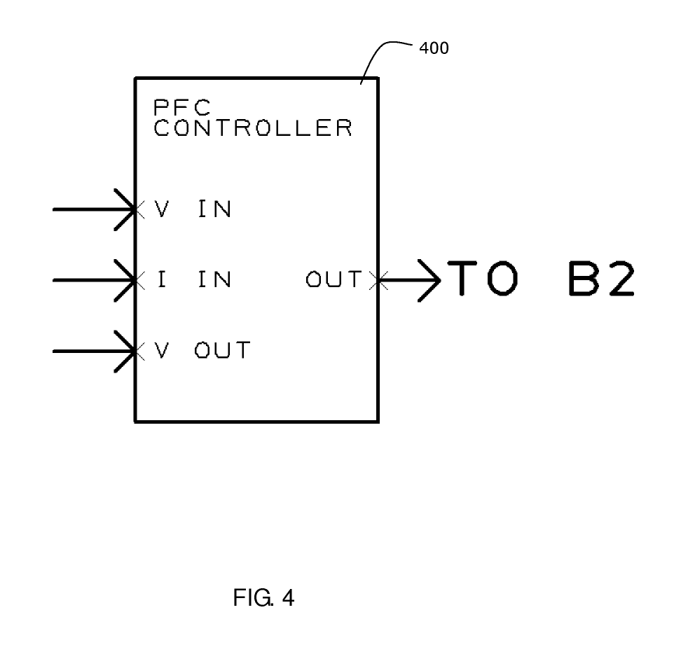

Other suitable configurations of a different topology DC/DC converter stage may be used such as, for example, half bridge, full bridge, forward, and any other suitable configurations. The input current shaping circuit, comprises inductor B1, semiconductor switch B2, diode B3 and capacitor B4. A second control circuit controls semiconductor switch B2 such that the input current THD is reduced when operating from the AC Mains (Port 1) while controlling the output voltage across capacitor B4 to the desired level. In the illustrated embodiments, capacitor B4 is the DC bus. An example of the second control circuit for performing this detection and control function is further described with reference to FIG. 4. One suitable control circuit is a boost power factor correction (PFC) circuit, which maintains input current proportional to input voltage.

The second control circuit may also control semiconductor switch B2 such that the low frequency input current is reduced when operating from the DC backup (Port 2) while controlling the output voltage across capacitor B4 (DC bus) to the desired level. The boost power factor correction (PFC) circuit, which maintains input current proportional to input voltage, is also one suitable control circuit for this purpose.

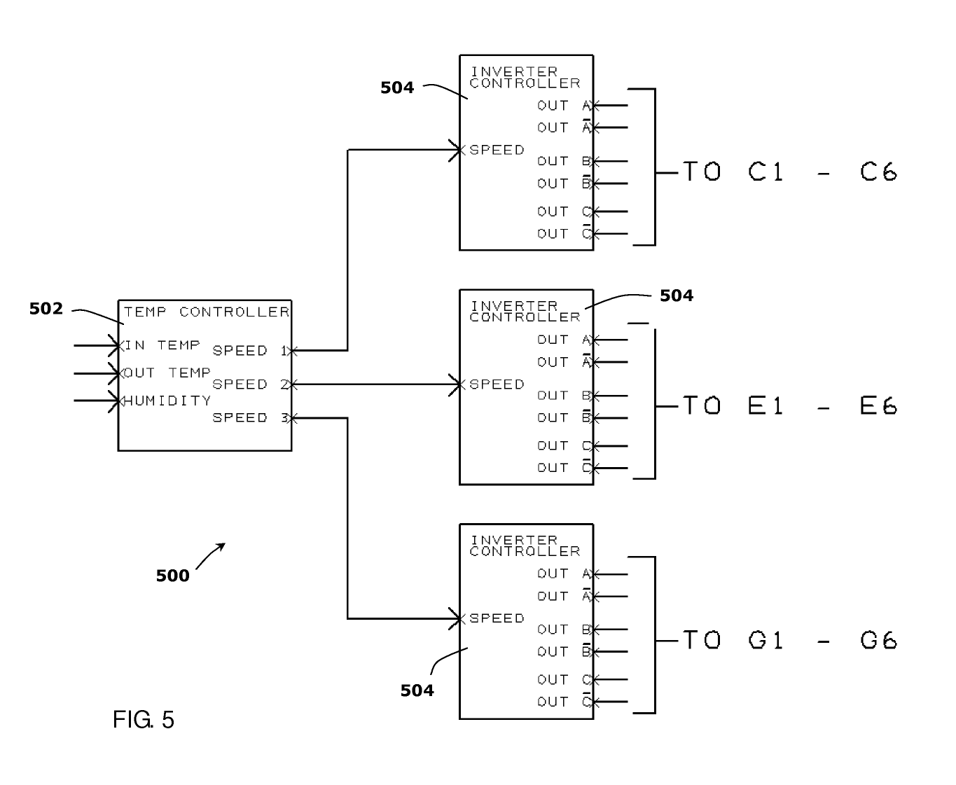

A DC/AC inverter comprises semiconductor switches C1 to C6, which is suitable for driving an air conditioner compressor motor D1. In one embodiment, the air conditioner compressor D2 is driven by an AC motor or DC brushless motor D1. However, any suitable motor may be used. A third control circuit controls semiconductor switches C1 to C6 such that the voltage and frequency applied controls the speed of the motor, and hence capacity of the compressor to the desired level. An example control circuit for performing this control function is further described with reference to FIG. 5.

A DC/AC inverter comprising semiconductor switches E1 to E6 powers an outdoor fan motor F1. An outdoor fan F2 is driven by the outdoor fan motor F1, which may be an AC motor or DC brushless motor F1. The third control circuit controls semiconductor switches E1 to E6 such that the voltage and frequency applied controls the speed of the outdoor fan motor F1 to the desired level.

A DC/AC inverter consisting of semiconductor switches G1 to G6 powers an indoor fan motor H1. The indoor fan H2 is driven by the indoor fan motor H1, which may be an AC motor or DC brushless motor H1. The third control circuit controls semiconductor switches G1 to G6 such that the voltage and frequency applied control the speed of the indoor fan H2 to the desired level.

The illustrated motors D1, F1, and H1 are shown as three-phase motors. However, other suitable motors may be used, such as two-phase motors or other suitable motors, together with corresponding DC/AC inverter circuits. Also, while the illustrated embodiment includes the outdoor fan motor F1 to drive the outdoor fan F2 and the indoor fan motor H1 to drive the indoor fan H2, embodiments of the present invention can use one fan motor to drive both the outdoor fan F2 and the indoor fan H2. Accordingly, it will be known to a person skilled in the art that one or more motors may be used to drive any number of fans in a cooling system.

It should be noted that relay K1 is not required for all cases and is dependent on the criteria used to select operation from Port 1 or Port 2. It is, for example, not required when the peak voltage applied at Port 1 does not exceed the output voltage of the DC/DC converter circuit coupled to Port 2 when operation from Port 2 is desired. Omission or inclusion of relay K1 does not necessarily change the fundamental operation of this embodiment.

FIG. 3 is a circuit block diagram of a first control circuit 300 for use with the power control system, in accordance with embodiments of the present invention. The first control circuit to detect the conditions of Port 1 and Port 2 and to control relay K1 and semiconductor switches J2 and J3, and the control circuit selects operation from Port 1 or Port 2 accordingly based on the detected conditions of Port 1 and Port 2. In the illustrated embodiment, the first control circuit includes a source selector 300 that receives input from Port 1 and Port 2 and provides outputs to control relay K1 and to activate/deactivate pulse width modulation (PWM) controller 302. When Port 1 is selected, AC power is delivered via control relay K1. When Port 2 is selected, the main function of PWM controller 302 is to provide alternating control signals to the switches of the DC/DC converter circuit to convert the DC supply from Port 2 to AC for voltage transformation and galvanic isolation via a transformer. For some embodiments of the invention, the PWM controller may also control the pulse width of the switches of the DC/DC converter circuit to adjust the average voltage applied and hence output voltage and/or input and output current of the DC/DC converter circuit.

FIG. 4 is a circuit block diagram of a second control circuit 400 for use with the power control system, in accordance with embodiments of the present invention. The second control circuit 400 controls semiconductor switch B2 such that the input current THD is reduced when operating from the AC mains (Port 1), while the output voltage across capacitor B4 is controlled to the desired level. The illustrated embodiment of the second control circuit is a boost power factor correction (PFC) controller 400, which maintains input current proportional to input voltage, according to the proportion required for the operation of the cooling system. This same control circuit 400 may also control semiconductor switch B2 such that the low frequency input ripple current is reduced when operating from the DC Backup (Port 2), while the output voltage across capacitor B4 is controlled to the desired level.

FIG. 5 is a circuit block diagram of a third control circuit 500 for use with the power control system, in accordance with embodiments of the present invention. In the illustrated embodiment, the third control circuit 500 is suitable for determining the desired speed for the compressor, the speed of the indoor fan, and the speed of the outdoor fan based on predetermined factors, including, for example, the indoor temperature, the outdoor temperature and indoor humidity. The third control circuit 500 includes a temperature controller 502 and a plurality of inverter controllers 504. The temperature controller inputs include the inside temperature, the outside temperature, and the humidity. The speeds are determined based on these inputs and output to the inverter controllers 504. Each of the output speeds need not be the same and may be independently determined depending on the requirements each of the powered devices. Generally, the number of inverter controllers 504 corresponds to the number of devices being controlled. In the illustrated embodiment, three inverter controllers 504 are included corresponding to the compressor, the outdoor fan, and the indoor fan.

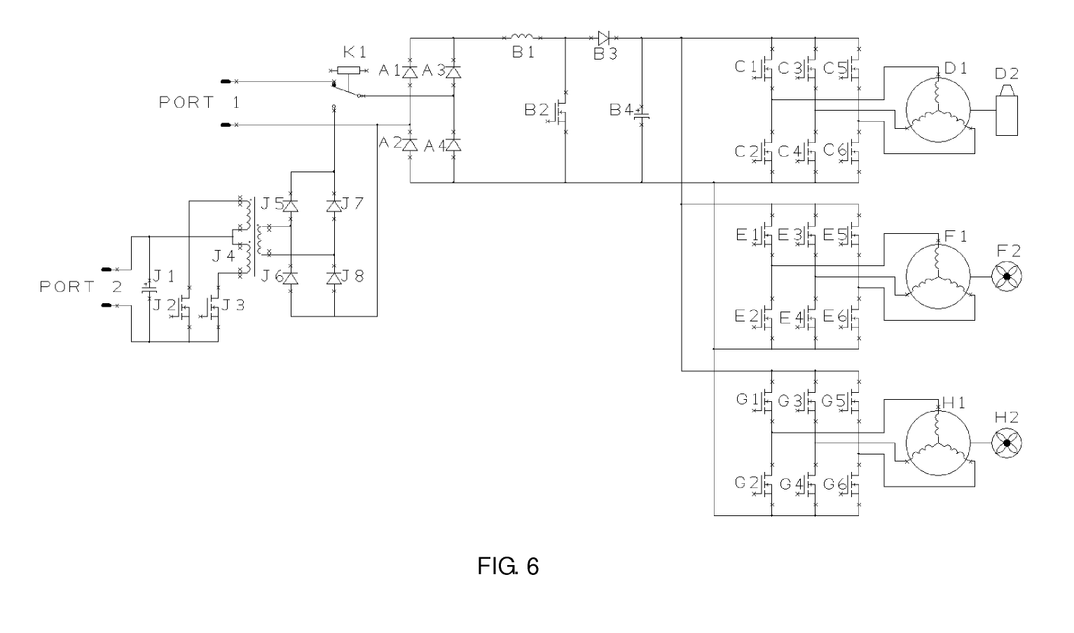

FIG. 6 is a circuit diagram of a power circuit, in accordance with an alternative embodiment of the present invention. The alternative embodiment of the power circuit shown in FIG. 6 operates similarly to the embodiment shown and described with reference to FIG. 2. The various control circuits and components of the air conditioning system are similarly incorporated in each of the alternative embodiments of the power circuit as described with reference to FIG. 2.

In the alternative embodiment illustrated in FIG. 6, relay K1 is connected as a changeover relay, such that operation from Port 1 or Port 2 can be selected depending on which pole of the relay is operated. A control circuit detects the conditions of Port 1 and Port 2 and controls relay K1 to select operation from either Port 1 or Port 2 accordingly, depending on the detected conditions. The output of the DC/DC converter, J1 to J8, is connected before the AC input rectification circuit, diodes A1 to A4, via changeover relay K1.

The embodiment shown in FIG. 6 provides similar performance to the preferred embodiment in FIG. 2, except that there may be additional losses in rectifier diodes A1 to A4 in FIG. 6 during operation from Port 2.

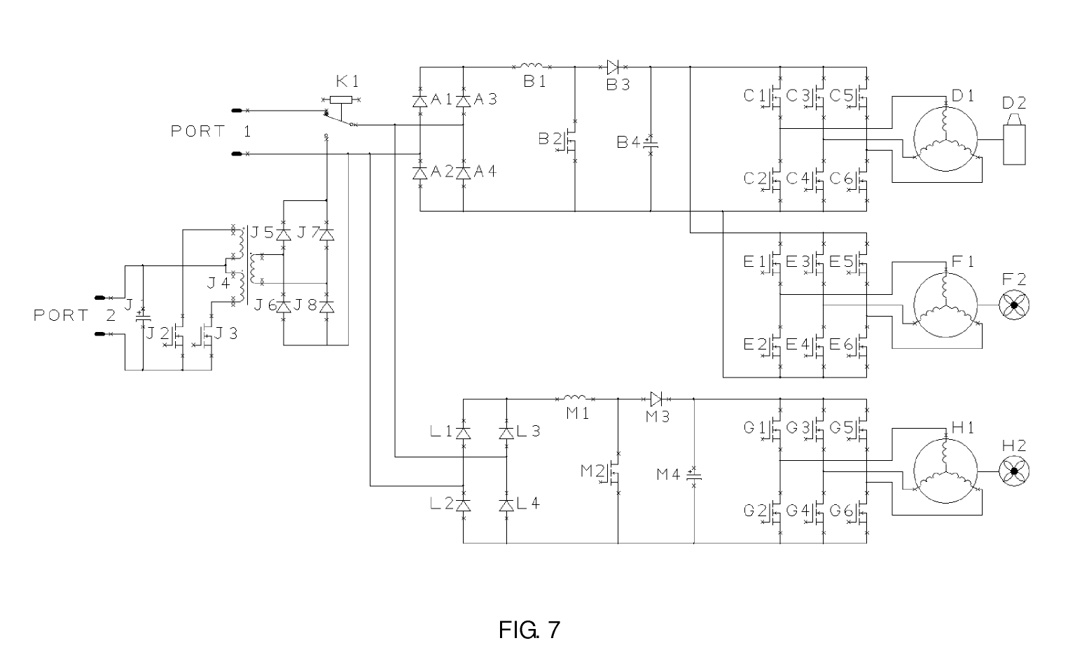

FIG. 7 is a circuit diagram of the power circuit, in accordance with an alternative embodiment of the present invention. The alternative embodiment of the power circuit shown in FIG. 7 operates similarly to the embodiment shown and described with reference to FIG. 6.

In the alternative embodiment illustrated in FIG. 7, power to the indoor fan motor H1 is supplied via independent rectification and input. The independent rectification and input is provided by an input rectification circuit including diodes L1 to L4 (AC to DC converter). An independent current shaping circuit including M1 to M4 is also included. Similar to the embodiment shown in FIG. 6, the embodiment illustrated in FIG. 7 may also have additional losses in rectifier diodes A1 to A4 during operation from Port 2. The embodiment illustrated in FIG. 7 also requires additional components of components L1 to L4 and M1 to M4, which are not required in the embodiments illustrated in FIGS. 2 and 6, and associated control circuitry.

The embodiment illustrated in FIG. 7 includes two independent channels such that the circuitry of each channel may be physically separated from each other. Each independent channel is coupled to both Port 1 and Port 2 via the control relay K1. The first channel includes input rectification circuitry of A1 to A4, current shaping circuitry including B1 to B4, a first switch C1 to C6 to control the motor D1, and a second switch E1 to E6 to control motor F1. The second channel includes input rectification circuitry of L1 to L4, current shaping circuitry including M1 to M4, and a third switch G1 to G6 to control the motor H1. Similarly, any number of independent channels may be incorporated with embodiments of the present invention. Additionally, any number of switches may be incorporated and controlled by each channel to support any desired number of cooling system devices.

The embodiment of FIG. 7 has a further advantage in that the input supply for the indoor fan H2 is separated from the input supply for the outdoor fan F2 and compressor D2, which can allow for implementation in a split air conditioning configuration where the outdoor fan F2 and compressor D2 are physically separate from the indoor fan. It also facilitates the use of packaged electronically commutated (EC) fans, which can operate on both AC and DC.

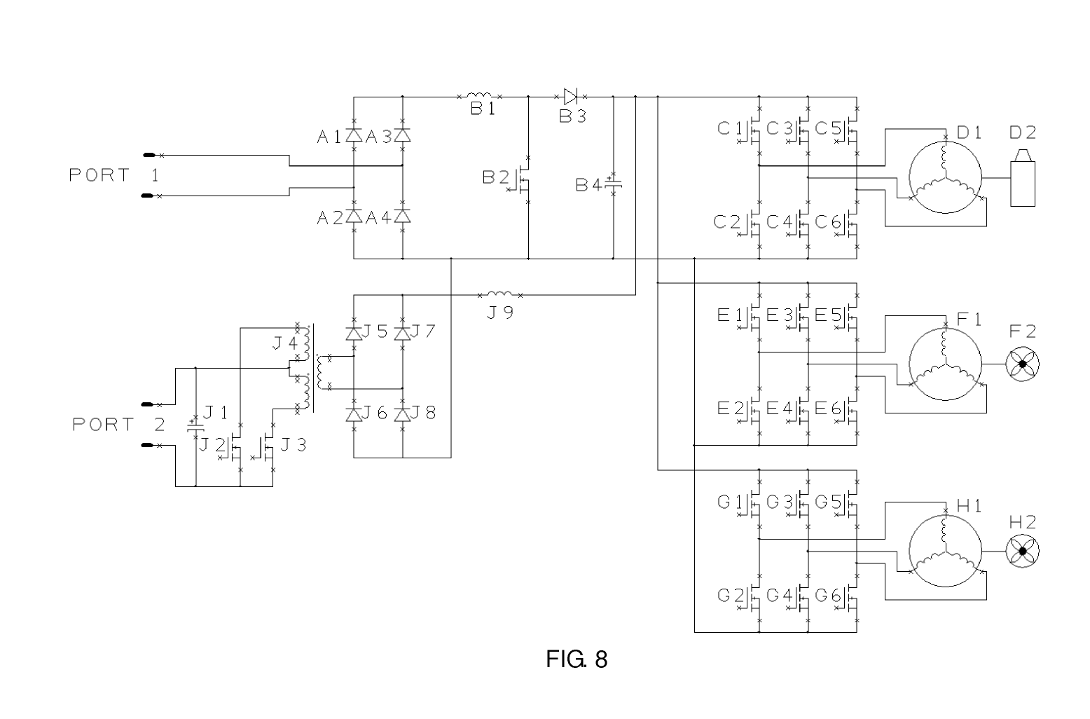

FIG. 8 is a circuit diagram of the power circuit, in accordance with an alternative embodiment of the present invention. The embodiment illustrated in FIG. 8 operates similarly to the embodiment illustrated in FIG. 2, but includes an additional inductor J9 in the output of the DC/DC converter circuit (J1 to J9). The output of the DC/DC converter circuit is connected across the output of the input current shaping circuit (B1 to B4), instead of the input to the input current shaping circuit. In many cases, and as illustrated in the embodiment of FIG. 8, relay K1 can be omitted in this configuration. The various control circuits and components of the air conditioning system are similarly incorporated as described with reference to FIG. 2

The embodiment in FIG. 8 has the advantage that a controlled amount of power can be drawn from both Port 1 and Port 2 simultaneously, without one port causing disturbances at the other port. This can be beneficial in cases when the amount of power from either port is limited for some reason, such as the cooling system being powered from a small capacity diesel generator, for example. In this embodiment a control circuit controls DC/DC semiconductor switches J2 and J3 and input current shaping circuit's semiconductor switch B2 to control the amount of power delivered from each of the supply ports.

However, connection in this way precludes the input current shaping circuit (B1 to B4) from controlling the voltage across capacitor B4 to the desired level, or from controlling the low frequency input ripple current (distortion), when operating from Port 2. It is, however, possible for the DC/DC converter circuit to act as an input current shaping circuit and control the low frequency input ripple current and the voltage across capacitor B4, but with additional requirements on control circuitry. Also, operation at reduced pulse widths increases high frequency ripple currents at Port 2, necessitating greater filtering.

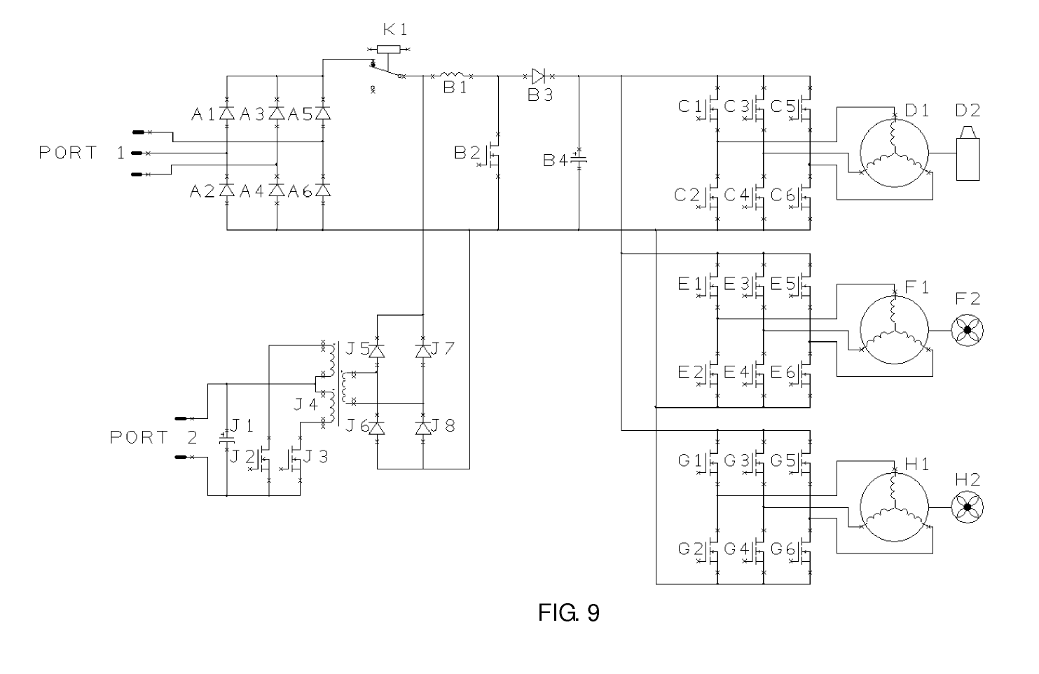

FIG. 9 is a circuit diagram of the power circuit, in accordance with an alternative embodiment of the present invention. The embodiment illustrated in FIG. 9 operates similarly to the embodiment illustrated in FIG. 2, but includes two additional diodes A5 and A6 which allow Port 1 to be connected to a three phase AC supply. This embodiment could be used, for example, where the power consumed by the cooling system exceeds the level readily supplied by a single phase supply, or in other cases where operation from a three phase supply is desired. In this illustration the relay K1 has been placed after the rectification diodes A1 to A6, but multiple relays or multipole relays could be utilized to disconnect each AC line before rectification diodes A1 to A6 if desired. Similarly, as described in the case for FIG. 2, the relay K1 can be omitted in some cases without fundamentally changing the operation of the embodiment.

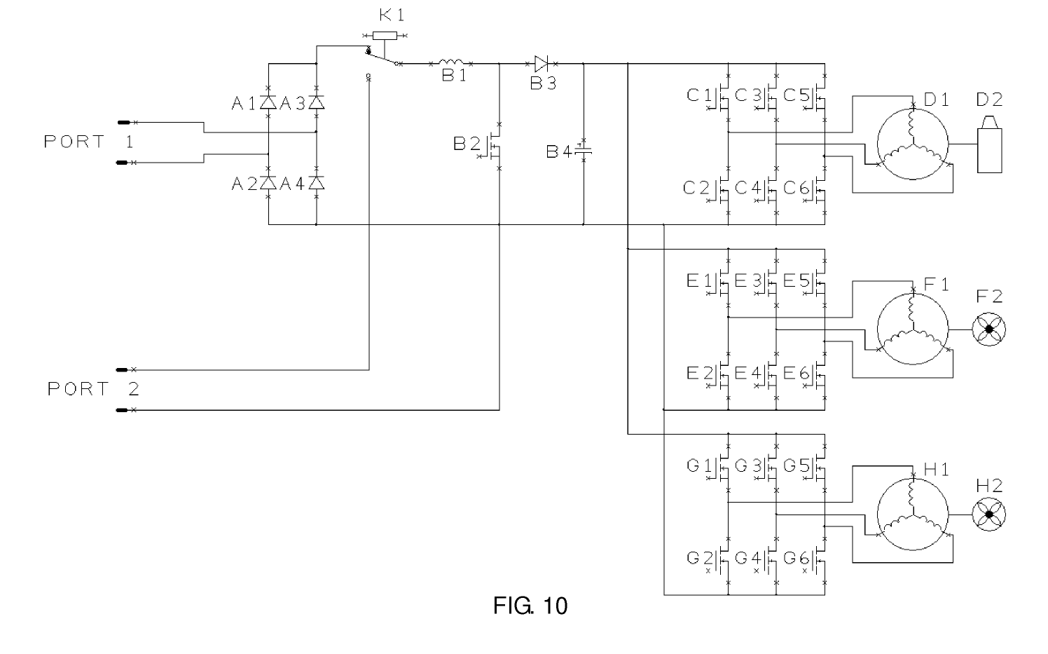

FIG. 10 is a circuit diagram of the power circuit, in accordance with an alternative embodiment of the present invention. The embodiment illustrated in FIG. 10 operates similarly to the embodiment illustrated in FIG. 2, together with associated control circuits, but excludes the DC/DC converter circuit components J1 to J8 and associated PWM control controller circuit 302 (shown in FIG. 3). Also, in this embodiment, relay K1 is positioned after the rectification diodes A1 to A4 and is configured as a changeover relay. This embodiment could be used, for example, for cases where the voltage of the DC backup supply to Port 2 is compatible with the level required for the input to the current shaping circuit B1 to B4 and galvanic isolation is not required for Port 2.

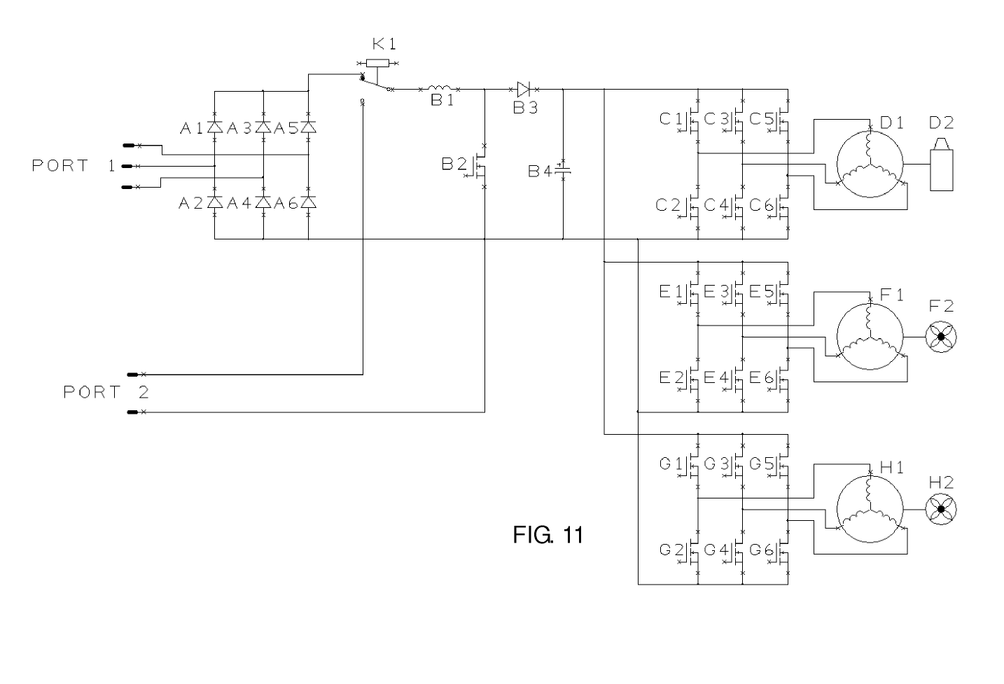

FIG. 11 is a circuit diagram of the power circuit, in accordance with an alternative embodiment of the present invention. The embodiment illustrated in FIG. 11 operates similarly to the embodiment illustrated in FIG. 10, together with associated control circuits, but includes two additional rectification diodes A5 and A6 to allow operation from a three phase AC supply to Port 1.

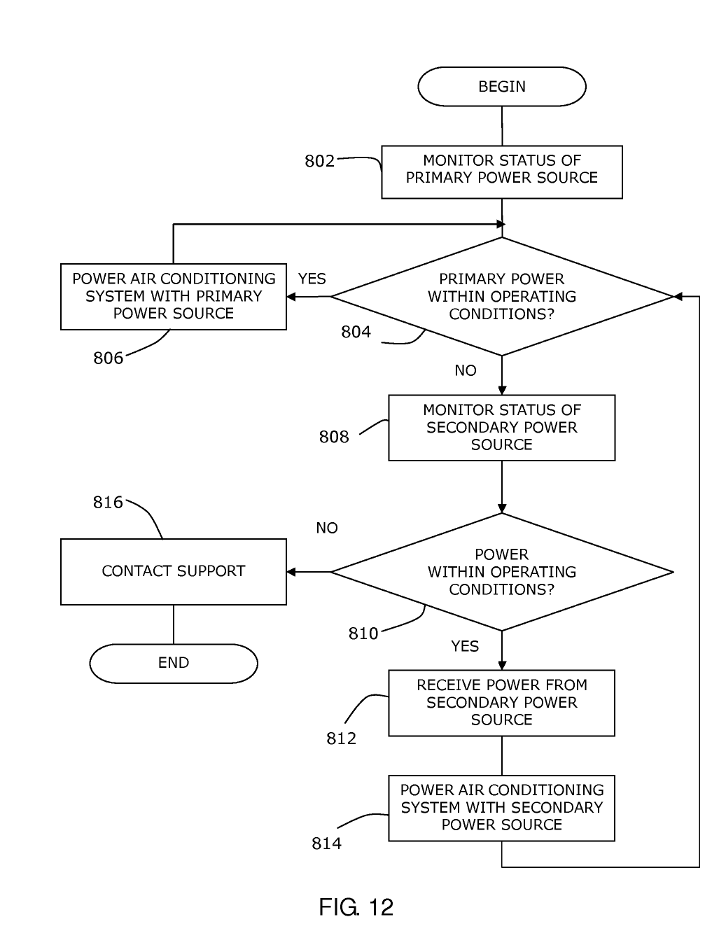

FIG. 12 is a flowchart diagram illustrating a power control decision process, in accordance with an embodiment of the present invention. In step 802, the power control system monitors the status of the primary power source, which is the AC power received through Port 1. In step 804, the system determines whether the primary power source is within the required operating conditions. If yes, then the air conditioning system is powered with the primary power source, 806. If no, the system monitors the status of the secondary power source, which is the DC power received through Port 2, 808. The primary power source being outside of the operating conditions is typically indicative of an AC power failure. While the air conditioning system is being powered by the primary power source, the system will return to step 804 to check if the primary power source is within the operating conditions. In step 810, the system determines whether the secondary power source is within the required operating conditions. If yes, then power is received from the secondary power source 812 and the air conditioning system is powered by the secondary power source. While the air conditioning system is being powered by the secondary power source, the system will return to step 804 to check if the primary power source is within the operating conditions, which would signal a restoration of the AC power source. If the AC power source has not been restored, then power by the secondary power source continues. If the AC power source has been restored, then the system proceeds to step 806. If the secondary power source is not within the required operating conditions, which may be an indication that the secondary power source has been depleted, then a central operations center may be alerted so that a physical inspection of the site may be made 816

It will be appreciated by those skilled in the art that the various circuits, switches, components, power supplies, and devices are coupled as described above such that they are in operable communication with each other, either directly or indirectly, as required by the specific implementation of embodiments of the invention.

The terms “uninterruptible” and “uninterruptible power supply” as used throughout this description are known in the field and the meaning of these terms will be appreciated by those skilled in the field. It will be appreciated that the term “uninterruptible” describes the presence of redundancy in case of any disruption or interruption in the delivery of primary power (typically AC mains) to the powered device. It should be appreciated that applications of the present invention (including the field of the invention herein described) may in some cases permit or even desire a temporary interruption in cooling operation within acceptable limits. “Uninterruptible” as used in this description, therefore, means the ability to continue to operate without interruption, or to operate following a temporary interruption, from a secondary power source in the case of any disruption or interruption in delivery of the primary power supply.

It will also be appreciated that the one or more control circuits use uninterruptible power in order to operate in conjunction with the uninterruptible cooling system. Accordingly, for example, the one or more control circuits are alternately powered by either the primary power supply or the secondary power supply, similar to the delivery of power to the components of the cooling system. Also, other redundant methods of ensuring the delivery of power to the one or more control circuits may be used, such as separate or additional batteries or back-up power supplies.

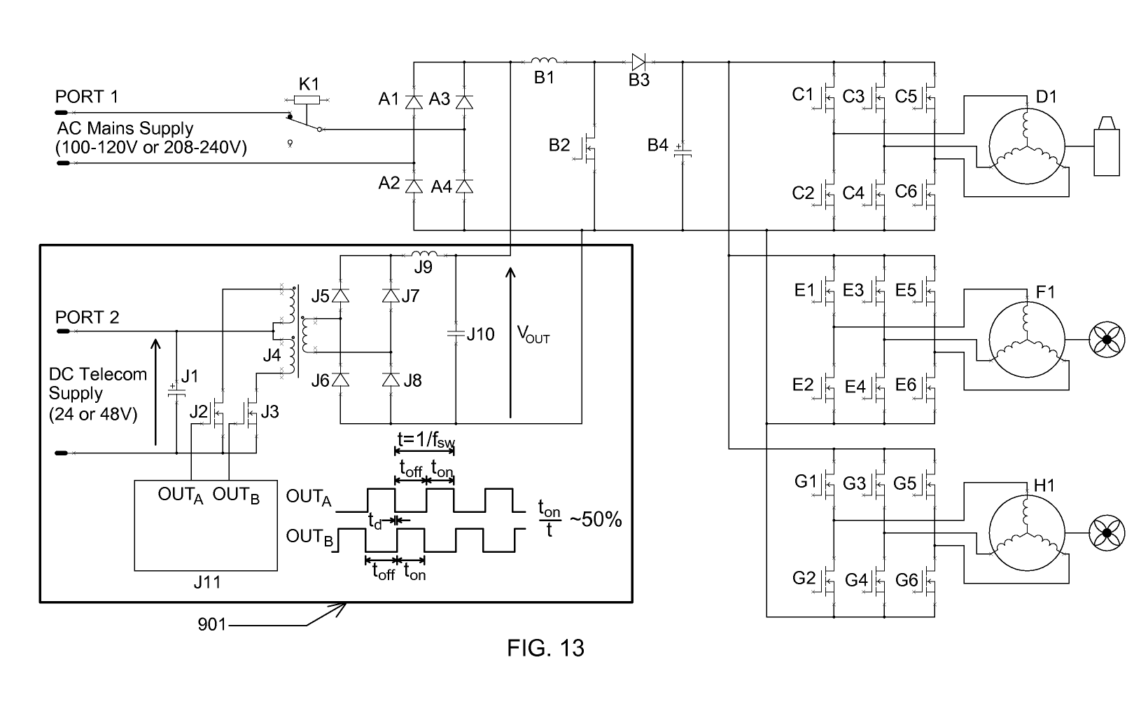

FIG. 13 includes further details of the power and control circuit particularly focusing on the operation of the DC/DC converter and input current shaping circuit (B1, B2, B3, B4) when operating from the DC backup supply (Port 2). The operation is explained using the preferred embodiment as a reference, but similar operation can be beneficially used in the embodiments illustrated in FIG. 6, FIG. 7 and FIG. 9.

In a typical telecom cooling application, Port 2 is connected to the Telecom DC power supply to provide a backup supply in the case of AC Mains failure. Two nominal DC voltages are commonly used for telecom equipment, namely 24V and 48V. The Telecom DC power supply is typically backed up by a battery (lead acid, or other type) ensuring uninterrupted DC power supply in the case of an AC Mains failure.

When the AC supply voltage at Port 1 exceeds specified conditions, a source selector (FIG. 3, 300) opens relay K1 and activates the DC/DC converter (FIG. 13, 901). A PWM controller or pulse generator (FIG. 13, J11 and FIG. 3, 302) provides pulses to alternately activate semiconductor switches J2 and J3. A switching frequency (fₛ in FIG. 13) of >20 kHz is selected to allow the use of a small high frequency transformer (J4) and to minimise the generation of audible noise. Input capacitor J1 filters the switching frequency ripple current. A fixed pulse width (tₒₙ in FIG. 13) of close to 50% (the maximum allowed in push pull and other double-ended topologies such as full bridge and half bridge) is chosen to reduce the switching frequency ripple current through input capacitor J1, reduce the size of the output filter components (J9 and J10), simplify zero voltage switching of semi-conductor switches J2 and J2 and improve the efficiency of the DC/DC converter. The use of a fixed pulse width also simplifies control circuitry compared to variable pulse width modulation control. A small dead time (t_{d}) is provided between the pulses applied to semiconductor switches J2 and J3 to prevent cross conduction and facilitate zero voltage switching of J2 and J3.

Alternately switching semiconductor switches J2 and J3 applies an AC square wave voltage at the switching frequency to transformer J4. The turns ratio of transformer J4 is selected to transform the nominal 24 or 48V at Port 2 to a RMS and peak voltage range compatible with the AC Mains connected to Port 1, allowing the same boost input current shaping circuit (B1, B2, B3, B4) to be beneficially configured for operation both from Port 1 when AC mains is within specified conditions and from Port 2 when AC mains exceeds specified conditions. Transformer J4 further provides galvanic isolation between Port 2 and Port 1.

Diodes J5, J6, J7, J8 rectify the AC squarewave voltage on the output of transformer J4 and inductor J9 and capacitor J10 filter the rectified AC squarewave to DC. Operation with a fixed pulse width of close to 50% allows the selection of low inductance and capacitance values for inductor J9 and capacitor J10, reducing size and cost of these components. In this embodiment, capacitor J10 also filters switching frequency ripple currents generated by the boost input current shaping circuit.

Telecom DC supplies require the AC ripple current in the frequency range of 20 Hz to 20 kHz of equipment connected to them to be below specified limits. As Port 2 is connected to a Telecom DC supply, the AC input ripple current at Port 2 is required to be below these specified limits.

Operating of the push-pull DC/DC converter (901) with a fixed pulse width causes the input current to the DC/DC converter to vary approximately proportionally to output current from the DC/DC converter.

During operation from Port 2, the boost input current shaping circuit (B1, B2, B3, B4) is configured to control the output current of the DC/DC converter (901) and thus also controls the input current to the DC/DC converter, due to the proportional relationship between the input and output current. The boost input current shaping circuit is controlled to reduce the AC component of the output current of the DC/DC converter such that the AC component of the input current to the DC/DC converter meets the Telecom DC supply specifications. A suitable control circuit for this is shown in FIG. 4.

The Telecom DC supply voltage at Port 2 can typically vary between around 20 to 30V for a nominal 24V supply and around 40 to 60V for a nominal 48V supply and as the DC/DC converter is operated with a fixed pulse width, its output voltage is not regulated and varies proportionally to its input voltage. The boost input current shaping circuit is thus configured to operate across a sufficiently wide voltage range and to control the voltage across the DC bus B4 to the desired level.

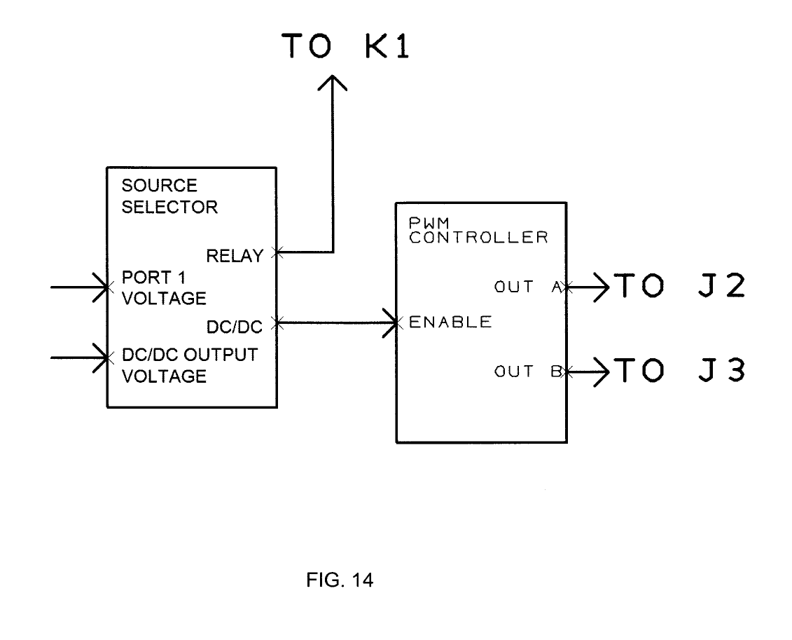

FIG. 14 includes further detail of the changeover relay control, applicable to the embodiments shown in FIG. 6 and FIG. 7.

In the embodiments shown in FIG. 6 and FIG. 7 the changeover relay (K1) alternatively connects AC supply from Port 1 to the input of the rectification diodes (A1, A2, A3, A4) when the AC supply at Port 1 meets specified conditions and connects DC supply from the output of DC/DC converter (J1 to J8) to the input of the rectification diodes (A1, A2, A3, A4) when the AC supply at Port 1 exceeds specified conditions. The changeover relay is thus required to alternatively switch AC and DC voltages and currents. DC voltages and currents are generally much harder to break using electromechanical devices, such as relay contacts, than AC voltages and currents, as the DC voltage and current does not periodically go to zero as in the case of AC voltages and currents. It is thus beneficial to reduce the DC voltage and current the relay contacts are required to break to avoid arcing and other damage to the relay contacts and extending the life and reliability of the relay.

For the embodiments shown in FIG. 6 and FIG. 7, a control circuit (FIG. 14, 1001) monitors the output voltage of the DC/DC converter (J1 to J8) and the AC input voltage at Port 1. If the AC input voltage at Port 1 exceeds specified conditions, the DC/DC converter is enabled and the changeover relay operated to disconnect the AC supply at Port 1 from the input of rectification diodes (A1, A2, A3, A4) and to connect the output of the DC/DC converter to the input of rectification diodes (A1, A2, A3, A4). Subsequently, if the AC input voltage at Port 1 meets specified conditions, first the DC/DC converter is disabled and its DC output voltage monitored. As the DC/DC converter has been disabled, its output voltage will drop. When control circuit detects that the DC output voltage has dropped below a specified limit, the changeover relay is operated causing the relay contacts to break the reduced DC voltage from the output of the DC/DC converter and to re-connect the AC supply from Port 1 to the input rectification diodes (A1, A2, A3, A4). The specified limit below which the DC/DC output voltage is required to drop before the relay is operated is selected such that the contact arcing is reduced to an acceptable level.

The control circuit (400 in FIG. 4) for the boost input current shaping circuit (B1, B2, B3, B4 in FIG. 6 and FIG. 7) is configured to control the input current to the boost current shaping circuit proportional to the input voltage to the boost current shaping circuit. Allowing the output voltage of the DC/DC converter to drop before operating the relay therefore also causes the DC current passing through the relay to be reduced proportionally, further reducing the arcing on the relay contacts when the relay is operated.

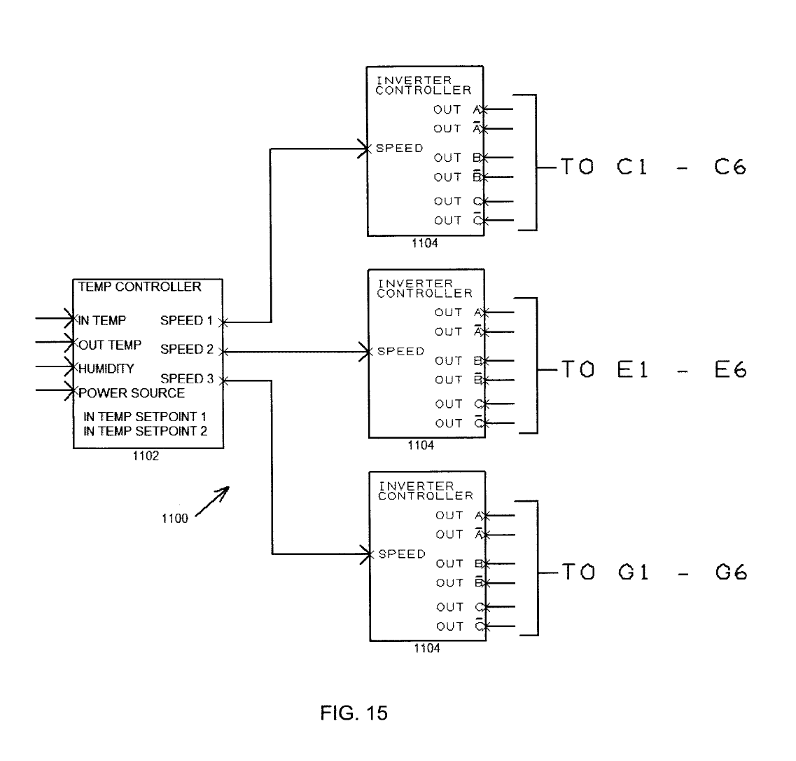

FIG. 15 includes further detail on the temperature control circuit for use with the with the power control system, in accordance with embodiments of the present invention. In the illustrated embodiment, the third control circuit 1100 is suitable for determining the desired speed for the compressor, the speed of the indoor fan, and the speed of the outdoor fan based on predetermined factors, including, for example, the indoor temperature, the outdoor temperature and indoor humidity. The third control circuit 1100 includes a temperature controller 1102 and a plurality of inverter controllers 1104. The temperature controller inputs include the inside temperature, the outside temperature, the humidity and the power source from which the cooling system is operating. The speeds are determined based on these inputs and output to the inverter controllers 1104. Each of the output speeds need not be the same and may be independently determined depending on the requirements each of the powered devices. Generally, the number of inverter controllers 1104 corresponds to the number of devices being controlled. In the illustrated embodiment, three inverter controllers 1104 are included corresponding to the compressor, the outdoor fan, and the indoor fan.

The temperature controller 1102 includes 2 inside temperature setpoints which correspond to cooling system operation from Port 1 and from Port 2. For operation from the battery backup source typically connected to Port 2, it may be desirable to allow a different temperature setpoint than for normal operation from the AC mains supply connected to Port 1. For example, the selection of a higher temperature setpoint will cause a corresponding reduction in power consumption of the cooling system, which can be beneficial for extending the battery backup time from a given size battery.

While the invention has been particularly shown and described with reference to the illustrated embodiments, those skilled in the art will understand that changes in form and detail may be made without departing from the spirit and scope of the invention. For example, while the embodiments of the present invention are described and illustrated with circuit diagrams, it will be appreciated that the invention may be implemented using integrated circuits, programmable logic devices, computer software, or a combination of any suitable implementations.

1. A cooling system comprising a compressor motor and a compressor operated by the compressor motor and a fan motor and fan operated by the fan motor, the cooling system comprising:
a first port configured for coupling with a primary AC power supply;
a second port configured for coupling with a DC secondary power supply, wherein the DC secondary power supply is a backup power source that allows the cooling system to operate when the AC primary power supply exceeds predetermined operating conditions;
a power circuit including a DC bus coupled to the first port and the second port via a boost input current shaping circuit, the power circuit configured to deliver power from the first port and the second port to the DC bus, the power circuit further including two pluralities of switches, the first plurality of switches configured to receive power from the DC bus and provide a first AC voltage to power the compressor motor, the second plurality of switches configured to receive power from the DC bus and provide a second AC voltage to power the fan motor.
a DC/DC converter configured to galvanically isolate the DC secondary power supply at the second port from the primary AC power supply at the first port and convert the voltage at the second port to a level suitable for input to the boost input current shaping circuit
at least one control circuit configured to control the first plurality of switches such that the voltage and frequency of the first AC voltage provided controls the speed of the compressor motor, the at least one control circuit further configured to control the second plurality of switches such that the voltage and frequency of the second AC voltage provided controls the speed of the fan motor, the at least one control circuit further configured to control power flow from the first port and power flow from the second port to the DC bus, the at least one control circuit further configured to control the boost input current shaping circuit to maintain input current proportional to input voltage and control the DC bus voltage.

2. The cooling system of claim 1, wherein the power circuit further includes an input rectification circuit and a changeover relay that alternately connects to the AC supply from the first port and the DC supply from the second port, wherein the changeover relay connects between the first port and the input rectification circuit when the cooling system operates from the AC primary power supply and the changeover relay connects between the output of the DC/DC converter and the input rectification circuit when the cooling system operates from the secondary power supply.

3. The cooling system of claim 2, further including a second input rectification circuit and second DC bus powering a third plurality of switches, the third plurality of switches configured to receive power from the second DC bus and provide a third AC voltage to power a second fan motor, and whereby the input to the second input rectification circuit is connected in parallel with the input to the first input rectification circuit

4. The cooling system of claim 2, where the DC/DC converter is shut down before the changeover relay is operated such that the DC voltage and DC current that the relay contacts is required to break is reduced.

5. The cooling system of claim 1, wherein the power circuit further includes an input rectification circuit and a changeover relay that alternately connects to the AC supply from the first port and the DC supply from the second port, wherein the changeover relay connects between the output of the rectification circuit and the boost input current shaping circuit when the cooling system operates from the AC primary power supply and the changeover relay connects between the output of the DC/DC converter and the boost input current shaping circuit when the cooling system operates from the secondary power supply.

6. The cooling system of claim 1, wherein the at least one control circuit includes a circuit to adjust the speed of the compressor motor and the capacity of the compressor to control the temperature of the environment to be cooled.

7. The cooling system of claim 6 where the at least one control circuit further includes two indoor temperature setpoints which are selected based on the power source from which the cooling system is operating.

8. The cooling system of claim 1, wherein the at least one control circuit controls the boost input current shaping circuit such that the input current is proportional to the input voltage and the input current THD is reduced when operating from the first port coupled to the primary AC power supply.

9. The cooling system of claim 1, wherein the at least one control circuit controls the boost input current shaping circuit such that the input current is proportional to the input voltage and the low frequency input current is reduced when operating from the second port coupled to the DC secondary power supply.

10. The cooling system of claim 1, wherein the at least one control circuit further controls the speeds of the compressor motor and fan motor based on inputs including indoor temperature and outdoor temperature and indoor humidity.

11. The cooling system of claim 1 whereby the compressor motor is a DC brushless motor.

12. The cooling system of claim 1 whereby the fan motor is a DC brushless motor.

13. The cooling system of claim 1, wherein the at least one control circuit includes a source selector circuit to select operation of the cooling system from the first port or the second port based on operating conditions of the first port and the second port.

14. The cooling system of claim 1, where the DC/DC converter is operated with a fixed pulse width.

15. The cooling system of claim 14, where the boost input current shaping circuit controls the input current to the DC/DC converter by controlling the output current from the DC/DC converter.

16. A power control apparatus for delivering electrical power from a first power supply and a second power supply to an air conditioning system including a compressor and a fan, the power control apparatus comprising:
a first input port to receive power from the first power supply;
a second input port to receive power from the second power supply;
a DC/DC converter to provide power from the second power supply while providing galvanic isolation of the second power supply from the first power supply and voltage transformation of the second power supply;
a boost input current shaping circuit coupled to the first input port and the second input port, the boost input current shaping circuit having a DC bus;
a plurality of switches coupled to the first port and the second port by the boost input current shaping circuit, the plurality of switches configured to operate one or more cooling system devices; and
a control circuit configured to monitor power received from the first input, the control circuit further configured to monitor power received from the second input and selectively deliver power from either the first input or the second input based on predetermined operating conditions.

17. The power control apparatus of claim 16, further comprising a changeover relay coupling the input of the boost input current shaping circuit alternately to the first input port when the first power supply meets predetermined conditions and to the output of the DC/DC converter when the first power supply exceeds predetermined operating conditions.

18. The power control apparatus of claim 16, whereby the control circuit is further configured to control the boost input current shaping circuit to provide input current proportional to the input voltage with reduced input current THD while controlling the DC bus voltage to the desired level when operating from the first port and input current proportional to input voltage with reduced low frequency input current while controlling the DC bus voltage to the desired level when operating from the second port.

19. The power control apparatus of claim 16, further comprising a second input rectification circuit coupled to the first port and the second port, the second input rectification circuit having a second DC bus and a second plurality of switches connected to the DC bus and configured to operate one or more cooling system devices.

20. The cooling system of claim 19 where the fixed pulse width is close to 50%.
